(19) United States
(12) Patent Application Publication
(10) Pub. No.: US 2007/0109091 A1
(43) Pub. Date: May 17, 2007

(54) Method for measurement of temperature coefficients of electric circuit components

(76) Inventors: Leslie M. Landsberger, Quebec (CA); Oleg Grudin, Quebec (CA); Gennadiy Frolov, Quebec (CA)

Correspondence Address: OGILVY RENAULT LLP, 1981 MCGILL COLLEGE AVENUE, SUITE 1600, MONTREAL, QC, H3A2Y3, CA

(21) Appl. No.: 10/549,583

(22) PCT Filed: Mar. 19, 2003
(86) PCT No.: PCT/CA03/00381

§ 371 Date: Nov. 17, 2006

(51) Int. Cl. H01C 3/04; H01C 7/04

(52) U.S. Cl. 338/25

(57) ABSTRACT

There is described a method and circuit for determining a temperature coefficient of change of a parameter of an electrical component, the method comprising: providing at least one thermally-isolated micro-platform on a substrate; placing an electrical component on the at least one thermally-isolated micro-platform; heating the electrical component; measuring a parameter value of the electrical component at a plurality of temperatures; and determining the temperature coefficient based on the measured parameter values.

### FIELD OF THE INVENTION

The invention relates to the field of measuring temperature coefficients of components. More particularly, it relates to on-chip measurement of the temperature coefficient of an electric circuit component positioned in or on thermally isolated microstructures.

### BACKGROUND OF THE INVENTION

Temperature coefficients of electronic components are very important in the industrial electronics and microelectronics fields. The electrical properties of all materials may, in general, vary as a function of ambient temperature. Since electrical components, devices and circuits must operate in potentially changing surroundings, this is problematic for designers of analog circuits and systems where fine calibration is important for proper function. Designs must take into account temperature coefficients and their level of uncertainty, and attempt to compensate for absolute and relative variations of components with temperature.

Since they are so important, the effective and efficient measurement of these temperature coefficients is also very important. At present, this is problematic in the industry. In order to measure the temperature coefficients, one must raise the temperature of the component (e.g. resistor, capacitor, inductor, transistor, op-amp, or larger circuit), to one or more known elevated temperatures, and simultaneously measure the electrical parameter in question. This is typically done by placing the entire chip or circuit or system in an oven. Because of the large thermal inertia of the oven, such measurements are time consuming, even more so if one desires to make the measurements more than once, for example as part of a burn-in procedure.

Among electronic components, resistance elements are pervasive and their behavior with temperature is very important in the design and operation of many circuits. The temperature coefficient or coefficients of resistance (TCR) are important parameters of most commercial resistance elements. One may be concerned with the first order variation with temperature, or also with the coefficients of higher order variations, (such as for the square of temperature, cube of temperature, the fourth power of temperature, etc.).

Typical methods for measurement of TCR involve the use of an oven to heat the entire chip or system. Because of the large thermal inertia of the oven, such measurements are time consuming, much more so than adjustment of resistance by any of the currently known or common methods (laser, screwdriver, electrical signals Indeed, Burr-Brown (U.S. Pat. No. 4,356,379) has disclosed a method of heating only a part of a monolithic integrated circuit chip by an on-chip heater. Since the mass of the oven is avoided, the heating and cooling times can be much shorter This technique used dynamic pulses to heat a sub-region of the chip, while other regions remained at relatively lower temperatures. While this is an advantage over more traditional oven-based methods, the temperature achieved is limited, and the accuracy of the measurement at the elevated temperature is also limited, since the component can only remain at the elevated temperature for a very short time.

At present, there is no way to accomplish a stable measurement at an elevated temperature (e.g. 100° C.), in less than a few seconds, due to the thermal inertia of the chip, or chip and packaging. Therefore, there is clearly a need for rapid and accurate measurement of temperature coefficients, to high precision, to accompany any techniques used for trimming of the resistance.

### SUMMARY OF THE INVENTION

Accordingly, an object of the present invention is to perform effective measurement of the absolute or relative temperature coefficient or coefficients of an electronic component or components positioned in or on thermally-isolated microstructures. Another object of the present invention is to perform effective measurement of the absolute or relative temperature coefficient or coefficients of resistance (TCRs) of a resistor positioned in or on thermally-isolated microstructures.

It is also an object of the present invention to perform effective determination of the sign with respect to zero of the temperature coefficient of an electronic component positioned in or on a thermally-isolated microstructure.

It is also an object of the present invention to perform effective determination of the sign with respect to zero of the temperature coefficient of a resistor positioned in or on a thermally-isolated microstructure.

It is also an object of the present invention to perform effective measurement of the relative temperature coefficient or coefficients of more than one component or circuit element, such as a resistance element, positioned in or on one or more thermally-isolated microstructures.

According to a first broad aspect of the present invention, there is provided a method and circuit for determining a temperature coefficient of change of a parameter of an electrical component, the method comprising: providing at least one thermally-isolated micro-platform on a substrate; placing an electrical component on the at least one thermally-isolated micro-platform; heating the electrical component; measuring a parameter value of the electrical component at a plurality of temperatures; and determining the temperature coefficient based on the measured parameter values.

According to a second broad aspect of the present invention, there is provided a circuit for determining a temperature coefficient of change of a parameter of an electrical component, the circuit comprising: a thermally-isolated micro-platform on a substrate; an electrical component on the at least one thermally-isolated micro-platform; heating circuitry for heating the electrical component; measuring circuitry for measuring a parameter value of the electrical component at a plurality of temperatures; and determining circuitry for determining the temperature coefficient based on the parameter value at the plurality of temperatures.

The present invention involves the use of local on-chip heating of a particular targeted component or components within a sub-region of a chip, to accomplish effective measurement of absolute or relative temperature coefficient or coefficients, consuming a time period of substantially less than a second.

### BRIEF DESCRIPTION OF THE DRAWINGS

These and other features, aspects and advantages of the present invention will become better understood with regard to the following description and accompanying drawings wherein:

FIG. 1: shows three examples of layouts intended to dissipate more power at the edges of the heat-targeted region;

FIG. 2: shows the electrical schematic of two functional resistors, and two heating resistors electrically isolated from the functional resistors;

FIG. 3: is a top view schematic of a possible configuration of the micro-platform with four resistors, suspended over a cavity;

FIG. 4: is a cross-sectional view of the structure shown in FIG. 3;

FIG. 5: shows an example of pairs of resistors on separate closely proximal micro-platforms;

FIG. 6: shows a possible embodiment for a trimmable thermal sensor (e.g. thermo-anemometer or thermal accelerometer), arranged on a single micro-platform with a slot;

FIG. 7: shows a possible embodiment of a thermal sensor (e.g. thermo-anemometer or thermal accelerometer), arranged on a plurality of micro-platforms;

FIG. 8: shows the electrical schematic of a bridge-based amplification circuit used to test rapid measurement of TCR.

### DETAILED DESCRIPTION OF THE PREFERRED EMBODIMENT

The concept of a micro-platform or microstructure suspended over a cavity in a substrate (such as a cavity micro-machined in silicon), including electrically-resistive elements for heating and/or sensing, is well-known in the literature (Canadian Microelectronics Corporation Report #IC95-08 September 1995; F. Volklein and H.Baltes, “A Microstructure for Measurement of Thermal Conductivity of Polysilicon Thin Films”, J. Microelectromechanical Systems, Vol. 1, No. 4, December 1992, p. 193, and references therein; Y. C. Tai and R. S. Muller, “Lightly-Doped Polysilicon Bridge as an Anemometer,” Transducers '87, Rec. of the 4th International Conference on Solid-State Sensors and Actuators 1987, pp. 360-363; N. R. Swart and A. Nathan, “Reliability Study of Polysilicon for Micro-hotplates,” Solid State Sensor and Actuator Workshop, Hilton Head, Jun. 13-16, 1994, pp. 119-122.). Micro-platforms with embedded resistive elements are commonly seen in micro-sensor, micro-actuator and micro-electromechanical systems (MEMS) literature since 1990 or earlier (e.g. I. H. Choi and K. Wise, “A Silicon-Thermopile-Based Infrared Sensing Array for Use in Automated Manufacturing,” IEEE Transactions on Electron Devices, vol. ED-33, No. 1, pp. 72-79, January 1986).

The concept of using a resistive heater to heat an entire suspended micro-platform or microstructure is also well-known in the literature. (C. H. Mastrangelo, J. H. -L. Yeh, R. S. Muller, “Electrical and Optical Characteristics of Vacuum-Sealed Polysilicon Micro-lamps”, IEEE Trans. Electron. Dev., vol. 39, No. 6, June 1992, pp. 1363-1375; N. R. Swart, and A. Nathan, “Reliability of Polysilicon for Micro-plates,” Solid-State Sensor and Actuators Workshop, Hilton Head, South Calif., Jun. 13-16, 1994, pp. 119-122; S. Wessel, M. Parameswaran, R. F. Frindt, and R. Morrison, “A CMOS Thermally-isolated Heater Structure as Substrate for Semiconductor Gas Sensors,” Microelectronics, Vol. 23, No.6, September 1992, pp. 451-456; M. Parameswaran, A. M. Robinson, Lj. Ristic, K. C. Chau, and W. Allegretto, “A CMOS Thermally Isolated Gas Flow Sensor,” Sensors and Materials, 2, 1, (1990), pp. 17-26.)

The method relates to the on-chip measurement of the temperature coefficient or coefficients, of an electric circuit component or components, positioned in or on thermally isolated microstructures. More specifically, it relates to the use of a resistive heater in the same or nearby microstructure to heat a single component for the purpose of measuring its absolute temperature coefficient or coefficients, or to heat a single component for the purpose of determining the sign of its temperature coefficient with respect to zero, or to heat multiple components for the purpose of measuring their absolute or relative temperature coefficient or coefficients.

In general, in order to accomplish the measurement of TCR, one could also use any on-chip micro-platform-based heater. In general, the TCR measurements are to be executed by on-chip-heater(s), that allow rapid heating and cooling of the resistor, which can effectively imitate variation of the ambient temperature. A viable solution is to use heaters potentially already deployed as trimming resistors, or other functional or auxiliary heater(s) to raise the temperature of functional resistor or resistors, to imitate variations of ambient temperature, such as might be found in oven-based testing, or in regular usage in temperature-varying conditions.

It should be noted that for the purpose of this document, thermally-isolated is meant to describe an element that is isolated from other elements such that the heat flux (proportional to temperature differential) generated between the element and other elements, is generally low. Electrically-isolated is meant to describe an element that is isolated from other elements such that the resistance between this element and other elements is very high (e.g. hundreds of k-ohms). The term signal is meant to describe any data or control signal, whether it be an electric current, a light pulse, or any equivalent. Furthermore, obtaining a constant or flat temperature distribution, T(x), is equivalent to a relatively flat or substantially constant temperature distribution across a resistor. The entire resistance cannot be at the same temperature since a portion of the resistor must be off the micro-platform (due to the continuous nature of resistors) and electrical contacts must be at a lower temperature. Therefore, obtaining a substantially constant temperature distribution across a resistor is understood to mean across a reasonable maximum possible fraction of the resistor. A pulse is to be understood as a short duration of current flow.

The (first-order) temperature coefficient of a circuit parameter is meant to be the constant of proportionality defining how that parameter varies with ambient temperature. Higher order temperature coefficients are meant to be higher order terms in a polynomial describing the variation of the parameter with temperature. For example, the polynomial describing how resistance varies with temperature would be: R(T)=K₁*T+K₂*T²+K₃*T³+ . . . , where K₁ would be the first order commonly known “TCR”, and K₂, K₃, etc. would be higher order temperature coefficients.

Fundamentally, the measurement of temperature coefficients of circuit elements positioned on an integrated circuit involves heating a small volume or area of the integrated circuit, and measuring the generally-temperature-sensitive parameter of a circuit component while the component is at an elevated temperature.

In general, this method aims to make such measurement of temperature coefficients more effective than in the prior art, by better heat localization, allowing lowering of thermal inertia and reduction of time required to raise and lower the temperature.

Therefore, to underlie the invention herein, an outline and discussion of certain modes of heating and heat localization is warranted. Measurement of resistance at elevated temperature involves the application of heat to a targeted region or component for a certain time period. Thus, almost by definition, this must be done by a heat pulse or pulses. If the behavior of the heating resistor is well-known and highly predictable, including knowledge of its TCR (including higher order terms), then effective heating can be done with a single well-designed pulse. In general, such pulses may have simple shape (e.g. square), or more complicated shape, depending on the desired variation of heating behavior with time.

Also, since such heating usually targets a particular resistive element localized in a certain sub-volume or sub-area of a larger (often integrated) device, the localization of the heat in and around the target elements may be of considerable importance. Specifically, the time-variation and spatial variation of heating in the target element(s) may be very important in the attainment of the desired temperature, which will be sensitively influenced by the combination of pulse and heat localization characteristics. Alternatively, heating could be done by providing a source of radiant heat (such as a laser), directed onto the micro-platform.

In DC/quasi-static and steady-state heating, one may use relatively long trimming pulses, such as 50 to 100 ms and longer, and the heated microstructure may or may not be relatively uniformly and entirely heated by those pulses. If one models the heated microstructure as being uniformly and entirely heated by those pulses, then one can estimate a maximum reasonable power Pₘₐₓ for many applications to be P=IV=I²R=V²/R=Pₘₐₓ=50 mW: For example, this could correspond to Rₕₑₐₜₑᵣ=500 Ω, (relatively low), I=10 mA, V=5V, (low enough for many user devices). With these parameters, in order to reach an elevated temperature of 100° C. -300° C., the microstructure must have thermal isolation higher than 2-4° K./mW. The numerical analysis above is also valid for the case of heating only a sub-region of the microstructure being heated. The geometry, materials, and layout of the structure must be properly designed to meet this requirement. For example, in a device based on a suspended microstructure, this translates to constraints on such parameters as length and width of supporting bridges, thickness, thermal conductivity of the layers making up the microstructure, depth of the cavity.

In any of the above cases, for rapid measurement of temperature coefficients, the temperature rise and fall times must be small. This requires low thermal inertia of the heated element, and high thermal isolation from surrounding objects which have higher thermal inertia. In the embodiments presented herein, the heating and cooling can be performed very fast, with typical time of 20-30 ms defined by the relatively low thermal inertia of the microstructure.

Zero-Crossing Determination or Uncalibrated Measurement of Absolute Temperature Coefficient of a Single Component: Thus a preferred embodiment of this invention consists of a single resistive element positioned in or on a thermally-isolated microstructure, accompanied by a resistive heater, positioned in or on the same microstructure, or a closely adjacent microstructure placed above the same micro-machined cavity. This basic configuration allows measurement of temperature coefficient(s) on an arbitrary or uncalibrated scale relative to zero, without requiring accurate knowledge of the actual temperature in the heated element. The heater heats the targeted element, and observation of the trend in the electrical parameter of the targeted element allows an uncalibrated measurement, and determination of whether that electrical parameter is positive, zero, or negative. If only such an uncalibrated measurement or a zero-crossing determination is required, then the heater may be on the same or a separate microstructure, and it does not need to be temperature-calibrated.

Measurement of Absolute Temperature Coefficient of a Single Component: If, on the other hand a measurement of the absolute temperature coefficient is required, then the heater must be calibrated such that it generates a known temperature at the functional component. Of course, the so-calibrated heater must remain stable and accurate, otherwise there must be a stable and calibrated temperature sensing device in the vicinity of the functional component. If, for example, the functional component is subjected to high temperature during operation (or, for example during thermal trimming), then this may make it necessary for the TCR-measurement heater to be placed on a separate microstructure such that it is not subjected to the highest temperatures (and thus remains more stable and calibrated). The initial calibration of the device used to sense the temperature may be done by several methods, including using an oven. After such calibration, (if it is stable), it may be used many times to measure the temperature coefficient of a targeted functional element.

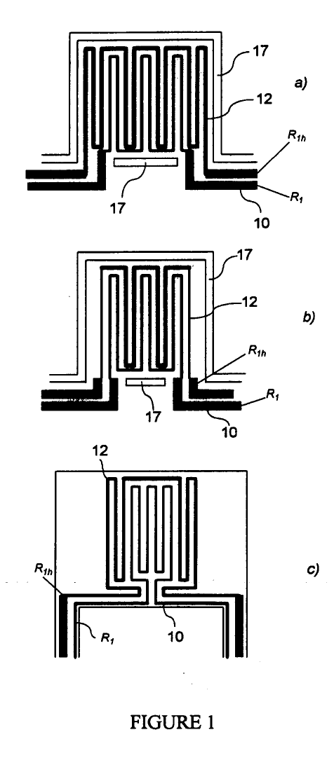

Uniform Temperature in Heated Component: Since the goal in measurement of temperature coefficient(s) is to imitate the effect of changes in the ambient temperature, effective determination or measurement of temperature coefficient(s) requires that the heated element be as much as possible at the same temperature. Therefore, measures should be taken to obtain a relatively constant temperature distribution in the heated element. For this purpose, we use layouts such as are shown in FIG. 1. Thus, for accurate control of heating in the functional resistor, it is important for the entire functional resistive element being heated to be maintained at the same (and controllable) temperature. Thus the spatial T profile, T(x) in the heat-targeted region, should be constant. However, since the heat-targeted element, even in steady state, is intended to be at a higher T than its surroundings, the boundaries of the heat-targeted region will tend to be at a temperature lower than the T at the center. In order to compensate for this, figures 1a, 1b, and 1c show examples of layouts intended to dissipate more power at the edges of the heat-targeted region. More power can be dissipated at the edges of the heat-targeted region by increasing the resistive path around the perimeter, and/or increasing the resistivity of the elements at the perimeter. It is preferable to have a major portion of the functional resistor having a flat temperature distribution. Therefore, a power dissipation geometry for the heating element can comprise supplying more heat around the edges of the functional resistor in order to counteract a faster heat dissipation in the edges and resulting temperature gradients across the thermally-isolated micro-platform.

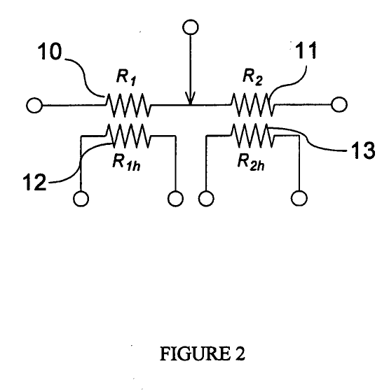

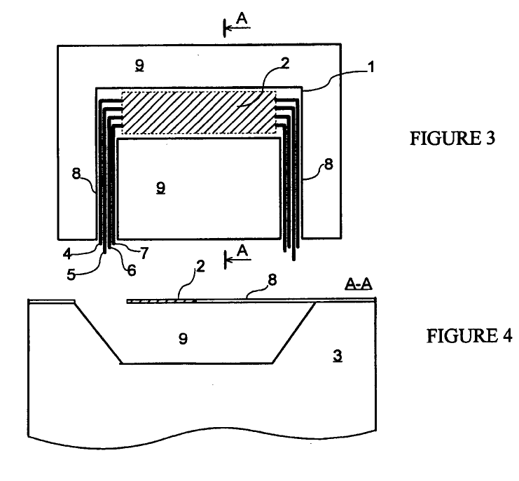

Zero-Crossing Determination or Uncalibrated Measurement of Relative Temperature Coefficient of a Plurality of Components Sharing an Operating Environment: For many applications, a combination of two or more resistors are used in a circuit. Some important cases include voltage dividers, R-R dividers, R-2R dividers, Wheatstone bridges, sensor input conditioning circuits, resistor networks. For example, the equivalent circuit of a simple voltage divider is shown in FIG. 2. These devices may be made to be very stable, even if the resistors have non-zero TCRs, as long as their TCR's are well-matched. For example, if the difference of the TCRs of the resistors is 0.001%/° K. (10 ppm), then a temperature imbalance of 10° K. will give a resistance mismatch of 100 ppm. In such cases, it can be important to measure the relative temperature coefficients, or at least to determine whether the relative temperature coefficients of two components is positive, negative, or zero. In such as case when the goal is to match the relative temperature coefficients, it is often not important that the measurement of the deviation from zero be calibrated. One possible configuration of this case is shown schematically in FIGS. 3-4. In this embodiment, two resistors are placed on the same thermally-isolated microstructure, and one or more heaters are additionally placed on the same thermally-isolated microstructure, in order to heat them.

FIG. 3 depicts a two-bridge cantilever 1, serving as a mechanical support for four resistors—two functional resistors R₁, R₂, and two electrically-heated resistors R₁ₕ, R₂ₕ. The resistors are placed on the central area 2 of the cantilever 1. The cantilever 1 is suspended over the cavity 9, etched in a silicon substrate 3, thus thermally isolating the cantilever 1 from the silicon substrate 3, which acts as a heat sink. Electrical connections to the resistors 4, 5, 6, 7, pass through two bridges 8 and enter the non-thermally-isolated region above the silicon substrate 3. FIG. 4 gives a cross-sectional view of the micro-machined structure.

In a preferred embodiment, standard micro-fabrication technology such as CMOS (or BiCMOS, or others), is used to fabricate resistive and dielectric layers to form the cantilever. It is well-known that such dielectric layers as silicon oxide and silicon nitride have low thermal conductivity. Therefore high thermal isolation (approximately 20-50° K./mW) can be achieved for the type of microstructure described here.

Resistors R₁, R₂, R₁ₕ and R₂ₕ can be made, for example, from polysilicon having sheet resistance of 20-100 Ω/square, which is typical for CMOS technologyA polysilicon resistor having resistance of 10 kΩ (for example) can be readily fabricated in an area of approximately 30 μm×30 μm, if a technological process having 1 μm resolution is used. For a 0.8 μm or 0.35 μm or smaller-feature-sized process, the size of the resistor can be significantly smaller. Therefore all four resistors, two functional with resistance of, for example, 10 k each, and two auxiliary, with preferably lower resistance such as approximately 1 kΩ, can be fabricated on the thermally isolated area 2 with typical area in an approximate range of 500 μm²- 20,000 μm², e.g. 50 μm×100 μm. This size is reasonable for many possible applications, and releasing of the whole structure can be done by well-known micro-machining techniques, for example chemical etching in an isotropic etchant solution(s), or isotropic dry silicon etch techniques.

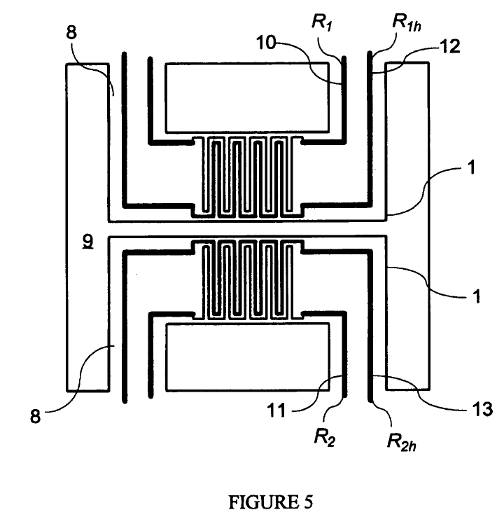

On the other hand, one can also co-design a pair of micro-platforms. One such alternative layout consists of two resistors located on two different thermally isolated membranes (for example over a common micro-machined cavity). Such a layout may be preferable in some circumstances. In some circumstances, even placement of the pairs of resistors (where each pair consists of one functional 10, 11 and one heating 12, 13 resistor), on a separate microstructure 1 as shown in FIG. 5, may offer certain benefits (may be preferable in some applications). As an example of a benefit: the structure may be heatable by a DC signal, (without short pulses), simplifying the heating procedure.

In the above cases, the heaters paired with the functional resistors would be used to raise the temperature of both resistors simultaneously. This scheme would be particularly effective if there were on-microstructure temperature sensing elements (such as thermocouples), which could be used to independently regulate the power applied to the two heaters, in order to equalize the temperatures at the two functional resistors. In this case, if one can count on the accuracy and stability of the temperature-sensing elements, the use of two separate heaters to heat the functional resistors is favorable. Indeed, if one can count on the stability and accuracy of the temperature-sensing elements, then this method can be used to measure absolute and relative TCR.

However, the sensitivity and offset of temperature-sensing elements can drift over time and use. If the two temperature-sensing elements drifted by different amounts, this would cause the measurements of the two functional resistors to be made at different temperatures, consequently degrading the accuracy and effectiveness of the measurement of temperature coefficients. For example, if polysilicon resistors in close proximity to the functional resistors were used to sense the temperature, and if those polysilicon resistors were ever subjected to high temperatures, (such as during high-temperature operation or during thermal trimming), then their accuracy and relative accuracy would potentially degrade. Similarly, if those same polysilicon resistors were further used as heaters, (for example, for a thermal trimming operation), their temperature-induced drift and consequent degradation of the accuracy would be greater.

Even so, if the temperatures reached by the pair of functional resistors were not equal, as long as the difference was a small fraction of the temperature rise, effective zero-crossing determination of the relative temperature coefficient would be obtained. However, if high accuracy in the zero-crossing determination were needed, and if the temperature-sensing elements were absent or prone to significant drift, then a single symmetrically-positioned heater may be more advantageous. In this case, even if the heater resistance drifted, the resulting temperature distribution would most likely still retain its symmetry (and the two functional resistors would remain at very-closely matched temperatures).

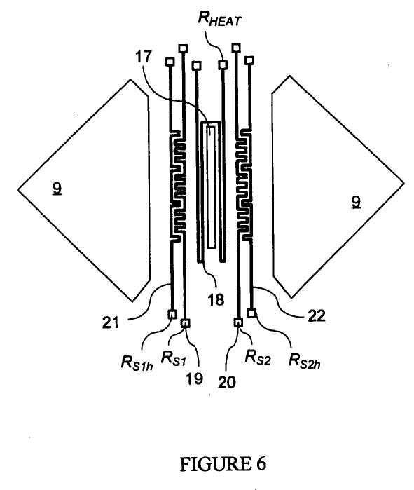

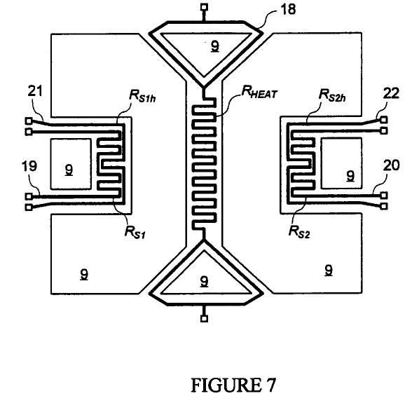

Use of Central Heater to Symmetrically Heat a Plurality: Thus an important configuration of the invented method is shown schematically in FIGS. 6 and 7 to address measurement of relative or relative temperature coefficients in the case where high precision and accuracy is required in the measurement.

An important example can be found using the structures depicted in FIGS. 6 and 7 in each case, the central heater resistor 18 can be used to symmetrically heat both functional resistors simultaneously. By its symmetrical position in between the two functional resistors, it heats both of them equally, simulating a realistic, uniform temperature rise, and allowing measurement of relative TCR difference between the two functional resistors.

The degree of precision achievable in this relative measurement is limited by the actual symmetry of the heat distribution achieved by the central heater. In principle, the symmetry obtainable by common batch micro-device manufacturing techniques is excellent.

FIGS. 6 and 7 show schematically two possible embodiments of three-element thermal sensor (e.g. thermo-anemometer, thermal accelerometer), with two functional temperature-sensitive elements R_{S1} 19 and R_{S2} 20 with accompanying heaters R_{S1h} 21 and R_{S2h}. The thermal sensor also contains the functional heater R_{HEAT} 18 placed between two temperature-sensitive elements 19 and 20. In the context of a typical thermo-anemometer or thermal sensor, the function of the heater 18 is to provide a heated air mass, which, under zero-input conditions, is symmetrically centered between the two temperature-sensitive elements 19 and 20. Under non-zero sensor input, this heated air mass is intended to be displaced in one direction or another, to be sensed by the temperature-sensitive elements. All functional elements 18, 19, 20 and auxiliary heaters 21 and 22 which may be manufactured, for example, from polysilicon, are disposed on one thermally isolated platform (FIG. 6) analogous to those described in U.S. Pat. No. 4,478,077 (Higashi, Honeywell). Modification of the shapes of openings to the cavity 9 and slot 17 (top view) transforms one platform into three separate ones shown on FIG. 7 with better mutual thermal isolation of functional elements. Note that one micro-platform can be also transformed into two separate micro-platforms with the central heater symmetrically distributed (in a two separate parts) on the two separate micro-platforms between the two temperature-sensitive elements. For both structures shown on FIGS. 6 and 7, the disclosed method of heating resistors Rₛ₁ 19, R_{S2} 20 can be applied. If functional resistors R₁ 10 and R₂ 11 (and perhaps more resistors) are sensing elements in a sensor, and the sensor output signal essentially depends on their resistance, the invented heating technique can be applied. For example, heated resistors can be a part of thermo-anemometers or thermal accelerometers or pressure sensors, such as in FIGS. 6, 7. This method can be used to heat devices and structures similar to those variations described in U.S. Pat. Nos. 4,472,239 and 4,478,076 (both Higashi, Honeywell). Those micro-machined structures contain a plurality of thermo-resistors placed on a suspended thermally-isolated plate having various configurations of slots and openings.

In this case, if one wanted to measure absolute or relative TCR (not only zero-crossing), then there would only be one heater whose effect on the overheating temperature of the functional components, would need to be calibrated.

In general, for all of the above-described techniques, when using this technique in conjunction with thermal trimming of a device, it is preferable to place the T-measurement heater (symmetric or not), outside of the regions which reach very high temperatures due to the thermal trimming, because of stability considerations.

As validation of the invented method of measurement of near-zero RTCR, the following experiments were executed.

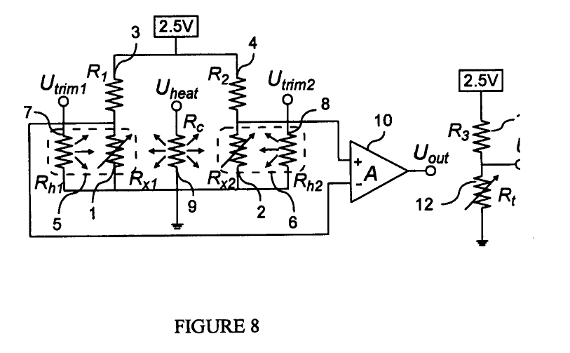

(a) Consider the bridge circuitry shown in FIG. 8. Two functional resistors Rx1 and Rx2, having resistance values approximately 5800 ohms, were positioned on suspended microstructures. Auxiliary resistive heaters Rh1 and Rh2 were also present on the suspended microstructures, adjacent to their corresponding functional resistors. These resistors were trimmable (according to the technique described in our patent and/or prior art). The bridge circuit was balanced by trimming one of the functional resistors such that the output of amplifier A was approximately zero at the ambient temperature.

(b) A traditional oven-based TCR measurement technique was used to measure RTCR of the bridge. The packaged chip was placed in the oven pre-heated up to approximately 100° C. for 3-4 minutes. Then it was plugged back in to the socket of the circuitry shown in FIG. 8. The output voltage (output of instrumentation amplifier A) was measured with time during cooling of the chip. Temperature of the chip was measured by measuring the voltage drop Uₜ across on-chip resistor Rₜ (with known TCR of approximately 900 ppm/K), connected in series with external resistor R₃. Then the temperature drift of the output voltage Uₒᵤₜ was calculated. The voltage difference across the diagonal of the bridge was calculated by dividing output voltage Uₒᵤₜ by the gain factor (400) of the amplifier A. Eventually RTCR of two resistors Rₓ₁ and Rₓ₂ was calculated from estimated temperature drift of voltage difference across the diagonal of the bridge and known resistance values R₁=R₂=5500 Ohm and bridge voltage of 2.5V.

(c) The invented procedure involves heating of the “central” resistive heater R_{c} placed on a separate microplatform thermally isolated from the two microplatforms containing resistors Rₓ₁, Rₕ₁ and Rₓ₂, Rₕ₂. The electric power dissipated in R_{c} results in temperature rise of the resistor itself and of the functional resistors Rₓ₁ and Rₓ₂. If the temperature distribution in the structure is symmetrical and resistors Rₓ₁ and Rₓ₂ are at the same elevated temperature, then the shift of output voltage Uₒᵤₜ is proportional to the RTCR of the two functional resistors. It was found experimentally that heating/cooling response time of the microplatforms defined by their low thermal inertia does not exceed 20-25 ms, which allows very fast RTCR evaluation.

(d) Comparison of the results on RTCR measurement executed in accordance with (b), (c) has been performed for several (>10) samples. It was found that at large deviation of RTCR from zero (either higher or less than zero), methods (b) and (c) gave the same sign of RTCR. When method (c) indicated near-zero or zero RTCR, method (b) showed either positive or negative RTCR (for different samples) with absolute RTCR value of less than approximately 5 ppm/K. The observed error in indication of RTCR provided by the invented method can be explained by non-symmetry in temperature distribution across the microplatforms. → For given poly-Si resistors Rₓ₁ and Rₓ₂ with TCR≈1000 ppm/K, difference in overheating temperature at about 0.5% of its absolute value gives 0.5% error in RTCR or exactly 5 ppm/K.

The accuracy of the invented method of fast measuring of RTCR can be improved a) with better symmetry of the layout of the structure, b) with lower absolute TCR of functional resistors. For example, the same non-symmetry as observed in the experiment gives only 0.5 ppm/K if TCR of functional resistors equals to 100 ppm/K.

Note that the heater might not be a resistive Heater: Note that the same heating could be provided from another heat source, such as a laser, or self-heating of the functional resistor itself. In these cases also, the heating and cooling times will be determined by the thermal inertia of the micro-platform, as discussed above. Therefore the whole manufacturing process can be substantially faster, as long as the resistor in question is thermally isolated, as on a micro-platform.

Of course, if we can measure at one T, we can measure at several elevated T's: For many applications, accurate knowledge of temperature behavior of TCR is required, including the higher-order terms describing variation with temperature. This requires measurement at a plurality of elevated temperatures. As another example, one could self-heat a functional resistor up to a known relatively high temperature, and then measure its resistance several known times as it cooled to room temperature at a known cooling rate.

It should be noted that the resistances within the restricted resistive regions need not be side-by-side on the microstructure. Instead, they may be arranged to be one over the other, as long as the electrical insulation between them is sufficient.

It will be understood that numerous modifications thereto will appear to those skilled in the art. Accordingly, the above description and accompanying drawings should be taken as illustrative of the invention and not in a limiting sense. It will further be understood that it is intended to cover any variations, uses, or adaptations of the invention following, in general, the principles of the invention and including such departures from the present disclosure as come within known or customary practice within the art to which the invention pertains and as may be applied to the essential features herein before set forth, and as follows in the scope of the appended claims.

1. A method for determining a temperature coefficient of change of a parameter of an electrical component, the method comprising:
providing at least one thermally-isolated micro-platform on a substrate;
placing an electrical component on said at least one thermally-isolated micro-platform;
heating said electrical component;
measuring a parameter value of said electrical component at a plurality of temperatures; and
determining said temperature coefficient based on said measured parameter values.

2. A method as claimed in claim 1, wherein said heating comprises providing a resistive heating element for heating said electrical component.

3. A method as claimed in claim 2, wherein said resistive heating element is provided on said thermally isolated micro-platform.

4. A method as claimed in claim 1, wherein said electrical component is a resistor and said heating comprises using resistive properties of said resistor to self-heat said resistor.

5. A method as claimed in claim 4, wherein said heating comprises applying at least one heat pulse to said electrical component.

6. A method as claimed in claim 1, wherein said determining said temperature coefficient comprises determining whether said temperature coefficient of said parameter is one of positive, negative, and zero.

7. A method as claimed in claim 6, wherein an acceptable margin is predetermined for determining if said temperature coefficient of said parameter is zero.

8. A method as claimed in claim 3, wherein said resistive heating element is provided with a power dissipation geometry such that a spatial temperature profile of said electrical component is substantially constant.

9. A method as claimed in claim 8, wherein said providing a power dissipation geometry comprises supplying more heat around edges of said electrical component in order to counteract a faster heat dissipation in said edges.

10. A method as claimed in claim 2, further comprising providing a second electrical component and said determining said temperature coefficient comprises determining a relative temperature coefficient of change of a parameter between said electrical component and said second electrical component.

11. A method as claimed in claim 10, wherein said second electrical component is provided on a second thermally isolated micro-platform on said substrate and said heating element is distributed substantially symmetrically between said electrical component and said second electrical component such that a heat pulse will heat said electrical component and said second electrical component in a substantially same manner.

12. A method as claimed in claim 11, wherein said heating element is provided on a third micro-platform between said micro-platform and said second micro-platform.

13. A method as claimed in claim 10, wherein said determining said temperature coefficient comprises determining whether said temperature coefficient of said parameter is one of positive, negative, and zero.

14. A method as claimed in claim 10, wherein said measuring a parameter value comprises measuring said parameter in a Wheatstone bridge.

15. A method as claimed in claim 10, wherein said second electrical component is provided on said thermally isolated micro-platform.

16. A method as claimed in claim 15, wherein said heating element is placed substantially symmetrically between said two electrical components on said micro-platform.

17. A method as claimed in claim 1, wherein said measuring comprises measuring said parameter as said electrical component cools down to said room temperature and using said cooling down measurements to determine said temperature coefficient of change.

18. A method as claimed in claim 1, further comprising measuring said parameter value at a plurality of elevated temperatures in order to determine how said temperature coefficient varies as a function of temperature.

19. A method as claimed in claim 1, wherein said micro-platform comprises a plurality of said electrical components, said heating of said electrical component comprising heating of said micro-platform to heat all of said electrical components at a same time, said measuring and said determining being performed substantially simultaneously for all of said electrical components.

20. A method as claimed in claim 1, wherein said measuring and determining is done in less than 1 second.

21. A method as claimed in claim 1, wherein said heating comprises raising a temperature of said electrical component using less than 1 milliwatts of power per degree Celsius of temperature rise.

22. A method as claimed in claim 1, wherein said heating comprises using less than 10⁻⁴ Joules per degree Celsius of temperature rise.

23. A circuit for determining a temperature coefficient of change of a parameter of an electrical component, the circuit comprising:
a thermally-isolated micro-platform on a substrate;
an electrical component on said at least one thermally-isolated micro-platform;
heating circuitry for heating said electrical component;
measuring circuitry for measuring a parameter value of said electrical component at a plurality of temperatures; and
determining circuitry for determining said temperature coefficient based on said parameter value at said plurality of temperatures.

24. A circuit as claimed in claim 23, wherein said heating circuitry comprises a resistive heating element for applying a heat pulse to said resistive heating element and heating said electrical component.

25. A circuit as claimed in claim 24, wherein said resistive heating element is on said thermally-isolated micro-platform.

26. A circuit as claimed in claim 25, wherein said heating element is positioned substantially symmetrically between said electrical component and a second electrical component.

27. A circuit as claimed in claim 24, wherein said heating element is positioned substantially symmetrically between said electrical component and a second electrical component, and wherein said second electrical component is on a second thermally isolated micro-platform and said heating element is on a third micro-platform between said micro-plaffonn and said second micro-platform.

28. A circuit as claimed in claim 24, wherein said heating element has a power dissipation geometry for such that a spatial temperature profile of said at least one electrical component is substantially constant.

29. A circuit as claimed in claim 28, wherein said power dissipation geometry comprises supplying more heat around edges of said electrical component in order to counteract a faster heat dissipation in said edges.

30. A method as claimed in claim 6, wherein determining comprises determining how positive, on an arbitrary scale, and how negative, on an arbitrary scale, said temperature coefficient is.

31. A method as claimed in claim 1, wherein said electrical component is a resistor.

32. A circuit as claimed in claim 23, wherein said electrical component is a resistor.
